(19) United States
(12) Patent Application Publication
(10) Pub. No.: US 2024/0003325 A1
(43) Pub. Date: Jan. 4, 2024

(54) FLOATING BODY

(71) Applicant: Joseph Saltsman, Fonda, NY (US)

(72) Inventor: Joseph Saltsman, Fonda, NY (US)

(21) Appl. No.: 18/052,722

(22) Filed: Nov. 4, 2022

Related U.S. Application Data
(60) Provisional application No. 63/367,359, filed on Jun. 30, 2022.

(51) Int. Cl. F03B 13/16; B63B 35/44

(52) U.S. Cl. CPC F03B 13/16; B63B 35/44; B63B 2035/4466; F05B 2220/706; F05B 2240/60

(57) ABSTRACT

An apparatus includes a floating body that reciprocates in a vertical direction based on motion. The apparatus includes a drive assembly that includes a drive connected to the floating body to move upwards and downwards in the vertical direction based on the movement of the floating body. The assembly includes at least one driving arm connected to the drive such that each driving arm of the at least one driving arm extends in a direction perpendicular to the vertical direction. The assembly include at least one cable coupling the at least one driving arm to a clutch on a drive shaft. The assembly includes the drive shaft, which rotates based on the movement of the floating body.

### CROSS-REFERENCE TO RELATED APPLICATIONS

This U.S. Patent application claims priority to U.S. Provisional Patent Application No. 63/367,359, filed Jun. 30, 2022, entitled Floating Body, the entire contents of which are hereby incorporated herein by reference.

### BACKGROUND

Hydroelectric power and thermal power generation are important sources or renewable energy. Hydroelectric power utilizes the physical environment of rivers, lakes, oceans, and other bodies of water to generate power for generators, etc. Harnessing wave energy can be utilized to power various systems.

### SUMMARY

Shortcomings of the prior art can be overcome and benefits as described later in this disclosure can be achieved through the provision of an apparatus for generating power from the movement of a floating body based on the motion of waves or any other reciprocal motion. The apparatus can include a floating body, where the floating body reciprocates in a vertical direction based on motion. The apparatus can also include a drive assembly, the drive assembly comprising: a drive connected to the floating body to move upwards and downwards in the vertical direction based on the movement of the floating body; at least one driving arm connected to the drive such that each driving arm of the at least one driving arm extends in a direction perpendicular to the vertical direction; at least one cable coupling the at least one driving arm to a clutch on a drive shaft; and the drive shaft, where the drive shaft rotates based on the movement of the floating body.

Shortcomings of the prior art can be overcome and benefits as described later in this disclosure can be achieved through the provision of an apparatus for generating power from the movement of a floating body based on the motion of waves or any other reciprocal motion. The apparatus can include: a floating body, wherein the floating body reciprocates in a vertical direction based on motion; and a drive assembly, the drive assembly comprising: a drive tower connected to the floating body to move upwards and downwards in the vertical direction based on the movement of the floating body; at least one driving arm connected to the drive tower such that each driving arm of the at least one driving arm extends in a direction perpendicular to the vertical direction; at least one cable coupling the at least one driving arm to a clutch on a drive shaft; and the drive shaft, wherein the drive shaft rotates based on the movement of the floating body.

Shortcomings of the prior art can be overcome and benefits as described later in this disclosure can be achieved through the provision of a method for generating power from the movement of a floating body based on the motion of waves or any other reciprocal motion. The method can include: placing an apparatus in a body of water, wherein the body of water experiences wave activity, the apparatus comprising: a floating body, wherein the floating body is positioned proximate to the body of water such that movement of the floating body comprises the floating body reciprocating in a vertical direction based on the wave activity; a drive assembly, the drive assembly comprising: a drive connected to the floating body to move upwards and downwards in the vertical direction based on the movement of the floating body; at least one driving arm connected to the drive such that each driving arm of the at least one driving arm extends in a direction perpendicular to the vertical direction; at least one cable coupling the at least one driving arm to a clutch on a drive shaft; and the drive shaft, wherein the drive shaft rotates based on the movement of the floating body; and extracting power from the apparatus based on the apparatus experiencing the wave activity, wherein based on the wave activity, comprising successive waves, the drive assembly moves upwards and downwards in the vertical direction and the drive shaft rotates clockwise during both the upwards and the downwards motion.

Shortcomings of the prior art can be overcome and benefits as described later in this disclosure can be achieved through the provision of an apparatus for generating power from the movement of a floating body based on the motion of waves or any other reciprocal motion. The apparatus can include: a floating body, wherein the floating body is positioned proximate to a body of water such that movement of the floating body comprises the floating body reciprocating in a vertical direction based on motion of waves within the body of water; and a drive assembly, the drive assembly comprising: at least one vertical drive tower coupled to the floating body to move upwards and downwards in the vertical direction based on the movement of the floating body; at least one driving arm connected to the at least one vertical drive tower such that each driving arm of the at least one driving arm extends in a direction perpendicular to the vertical direction; at least one cable coupling each driving arm of the at least one driving arm to a clutch selected from one or more clutches on one or more drive shafts; and the one or more drive shafts, wherein each of the one or more drive shafts rotates based on the movement of the floating body.

Shortcomings of the prior art can be overcome and benefits as described later in this disclosure can be achieved through the provision of an apparatus for generating power from the movement of a floating body based on the motion of waves or any other reciprocal motion. The apparatus can include: one or more floating bodies, wherein the one or more floating bodies are positioned proximate to a body of water such that movement of the one or more floating bodies comprises the one or more floating bodies reciprocating in a vertical direction based on motion of waves within the body of water; one or more drive assemblies, each of the one or more drive assemblies comprising: at least one vertical drive tower coupled to at least one floating body of the one or more floating bodies to move the at least one floating body upwards and downwards in the vertical direction; at least one driving arm connected to the at least one vertical drive tower such that each driving arm of the at least one driving arm extends in a direction perpendicular to the vertical direction; at least one cable coupling each driving arm of the at least one driving arm to a clutch selected from one or more clutches on one or more drive shafts; and the one or more drive shafts, wherein each of the one or more drive shafts rotates based on the movement of the at least one floating body of the one or more floating bodies.

Additional features are realized through the devices and techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts aspects of some embodiments of an apparatus described herein;

FIG. 2 depicts a floating body which is included in the apparatus of FIG. 1;

FIG. 3 depicts various aspects of some embodiments of the present invention;

FIG. 4 depicts various aspects of some embodiments of the present invention;

FIG. 5 is a block diagram that depicts various aspects of some embodiments of the present invention;

FIG. 6 depicts aspects of some embodiments of an apparatus described herein;

FIG. 7 depicts aspects of some embodiments of an apparatus described herein; and

FIG. 8 depicts some aspects of some embodiments of an apparatus described herein.

### DETAILED DESCRIPTION

The accompanying figures, which are not drawn to scale for ease of understanding, in which like reference numerals may refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

The terms “including” and “comprising”, as used herein, mean the same thing.

The terms “substantially”, “approximately”, “about”, “relatively,” or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1% such as less than or equal to ±0.05%. If used herein, the terms “substantially”, “approximately”, “about”, “relatively,” or other such similar terms may also refer to no fluctuations.

Embodiments of the present invention include a system, method, and apparatus for generating energy from reciprocating motion. Although certain figures illustrate these examples in the context of harvesting ocean wave energy, as understood by one of skill in the art, aspects of certain of the examples illustrated herein can be implemented in any environment to harvest energy from reciprocating motion.

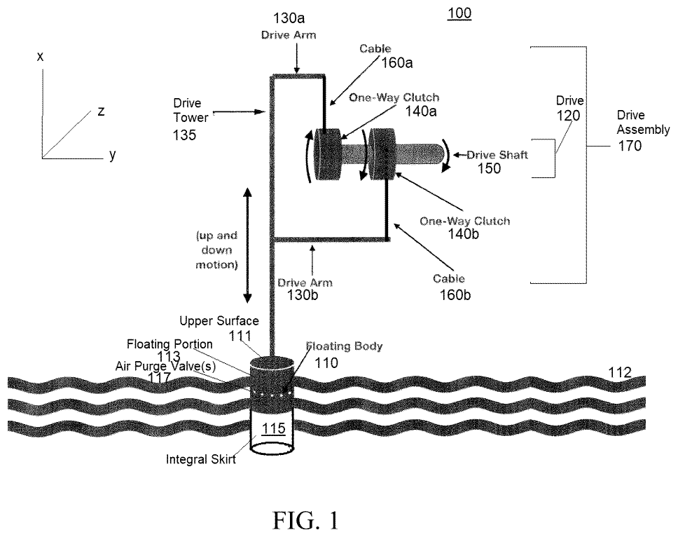

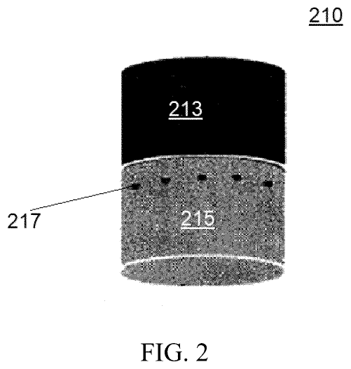

As illustrated in FIG. 1, aspects of the present invention, a power generation system 100, include a floating body 110 that reciprocates vertically with the wave motion. FIG. 2 depicts the floating body 200 itself without the other aspects depicted in FIG. 1. Reciprocating motion, also called reciprocation, is a repetitive up-and-down or back-and-forth linear motion. It is found in a wide range of mechanisms, including reciprocating engines and pumps. The two opposite motions that comprise a single reciprocation cycle are called strokes. Wave energy is a renewable energy with a high density. In the examples herein, the system described utilizes wave energy, including in the ocean, and provides a reciprocating wave power generation system.

Returning to FIG. 1, to indicate relative directions throughout the description of various aspects of the system and environment 100 depicted in FIG. 1, FIG. 1 includes three axis, an x-axis, a y-axis, and a z-axis. These axis indicate approximate directions of various elements of the system relative to each other, for illustrative purposes. Embodiments can include a fixed platform (not pictured) and a floating body 110 with a drive tower 135 that moves up and down.

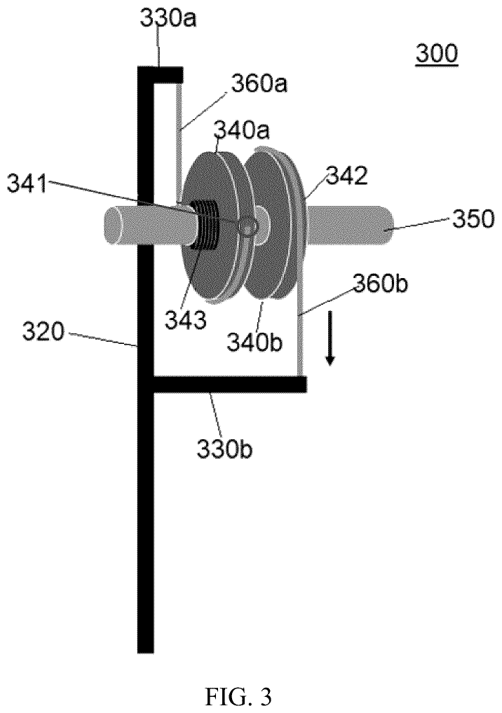

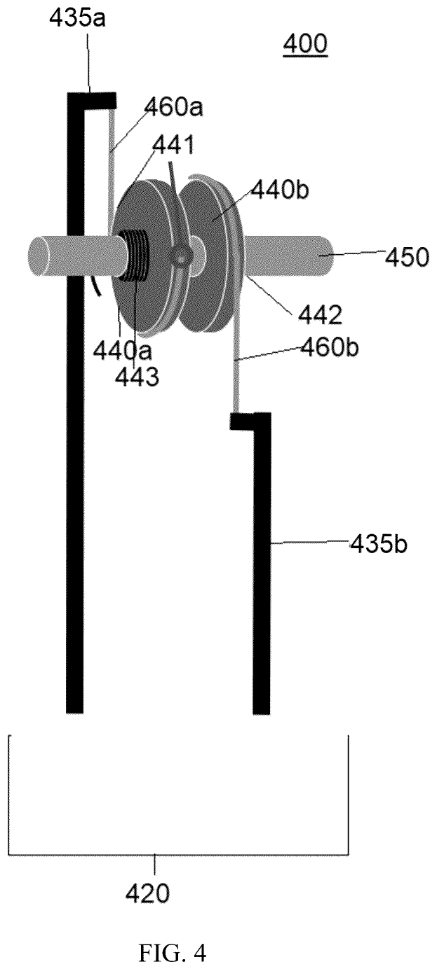

In FIG. 1, connected to the floating body 110 is a drive 120, which is a member that reciprocates with the floating body. In some examples, the drive 120 can be comprised of a rigid material, and the member is solid. The drive 120 can be comprised of various materials, including but not limited to, metal. In some embodiments, attached to the drive 120 are one or more drive arms 130a, 130b. FIG. 1 illustrates a non-limiting example of the floating body disclosed herein that include two drive arms 130a, 130b attached to the drive 120. In this example, as the drive 120 upward from an upper surface 111 of the floating body 110, on an axis, x that is perpendicular to both a y axis and a z axis, the upper surface 111 parallel to both these horizontals. The directions provided in this figure are relative and approximate and provided for illustrative purposes. The drive arms 130a, 130b are both connected to a vertical drive tower 135 and thus, the drive 120 includes a vertical drive tower configuration. In certain examples herein, an alternative configuration, referred to as a two vertical drive tower configuration can be utilized. FIG. 4 illustrates this two vertical drive tower configuration while FIG. 1, as well as FIG. 3, both illustrate a one vertical drive tower configuration.

Although FIG. 1 illustrates a single drive 120, which can also be understood as a (e.g., rigid) single vertical drive tower, in some examples, a drive assembly can include more than one vertical drive tower. The additional elements of the drive assembly can be duplicated in the same manner and/or each drive members can be coupled to a single drive shaft, or at least one drive shaft. As illustrated in FIG. 1, the first drive arm 130a and the second drive arm 130b, are each coupled to a drive shaft 150 via cables 160a, 160b, which are the fasteners utilized in this example but are not provided to suggest any limitations to what can be utilized to fasten the drive arms 130a, 130b to a clutch 140a, 140b of a drive shaft 150.

As illustrated in FIG. 1, the drive arms 130a, 130b reciprocate vertically with the floating body 110. In this example, both drive arms 130a, 130b are attached to one-way clutches 140a, 140b on the drive shaft 150 with cables 160a, 160b. As understood by one of skill in the art, a one-way clutch is a functional component utilized for transmitting or suspending torque, which transmits torque in one rotational direction while stopping torque transmission in the opposite direction. In this example, each drive arm 130a, 130b is attached with one cable 160a, 160b, although the number of cables can vary. In the non-limiting example with two cables, a first cable 160a, is attached to a backside of a first one-way clutch 140a, and a second cable 160b, is attached to the frontside of the second one-way clutch 140b. The attachments of the cables to the clutches are illustrated in more detail in FIG. 3.

FIG. 3 illustrates the aforementioned one (vertical) drive-arm tower configuration 300 (which includes a drive tower 335) utilized in some embodiments of the present invention. FIG. 3 also illustrates the attachment of the cables 360a, 360b to the one-way clutches 340a, 340b on the drive shaft 350. Based on the view provided in FIG. 3, one can view that the first cable 360a, is attached to a frontside 341 of a first one-way clutch 340a, and a second cable 360b, is attached to the backside 342 of the second one-way clutch 340b. The drive tower 335 moves up and down. When the drive tower 335 is moving upwards, the drive shaft 350 rotates in a first direction (e.g., clockwise). When the drive tower 335 moves in a downward direction, the drive shaft 350 can rotate in the same direction (e.g., clockwise). In this example, while the drive tower 335 moves upwards, the first cable 360a drives the drive shaft 350 clockwise via the one-way action of the first clutch 340a. Simultaneously, in this example, the second cable 360b is re-wound on the second one-way action of the clutch 340b with a recoil spring hidden behind the second clutch 340b in the view depicted in FIG. 3. During a downwards motion, the first cable 360a is re-wound on the first one-way clutch 340a, with the recoil spring 343 (this recoil spring is visible in the view provided in FIG. 3). Simultaneously, the second cable 360b drives the drive shaft 350 clockwise. In some examples, the direction in which the first one-way clutch 340a rotates when the first cable 360a is extracted from the first one-way clutch 340a opposes the rotation realized on the second one-way clutch 340b while the second cable 360b rewinds. When vertical motion (of the drive tower 335) reverses, the extraction-rewind roles on the clutched are reversed.

Returning to FIG. 1, as illustrated in this FIG. 1 as well as in FIG. 3, during an upwards motion, which we can refer to as up motion (in the context of FIG. 1, proceeding upward from the base of the x-axis), a wave 112 raise the drive assembly 170 (which includes the drive tower 135, the drive arms 130a, 130b and the cables 160a, 160b) also raises (moves upward) (in the context of FIG. 1, proceeding upward from the base of the x-axis). The first cable 160a drives the drive shaft 150 clockwise via one-way the first clutch 140a. Simultaneously, in this example, the second cable 160b is re-wound on the second one-way clutch 140b with a recoil spring (e.g., FIG. 3, 343). During a downwards motion (in the context of FIG. 1, proceeding downward on the x-axis), which we can refer to as down motion, as the wave 112 lowers the drive assembly, the first cable 160a is re-wound on the first one-way clutch 140a, with a recoil spring (e.g., FIG. 3, 343). Simultaneously, the second cable 160b drives the drive shaft 150 clockwise. This process repeats with each successive wave in some embodiments of the present invention.

Referring to depictions of the floating body 110, 210 in both FIGS. 1 and 2, the floating body 110, 210 is a flotation device that include a floating portion 113, 213 body with an integral skirt 115, 215 and one or more air purge valves in the skirt 117, 217. The air purge valves 117, 217 can also be understood as air bleed valves. A non-limiting example of the floating body is illustrated in FIG. 2.

Referring to FIG. 2, the floating portion 213 is a sealed flotation container. In some examples, the container is completely sealed. The integral skirt 215 is an open-bottomed skirt attached to the floating portion 213. The integral skirt 215 includes one or more (in this case more than one) one-way air bleed valves which are air purge valves 217. As the floating body 110, 210 rises with a wave 112, entrapped air will exit the integral skirt 215, a skirted cavity, while not letting air enter as the float descends (also with the wave 112 motion). As the wave rises, any entrapped air exits the skirted area via the air bleed valves. The result is water pushing up on the floatation portion 213. As the wave drops, the air bleed valves (also referred to as the air purge valves 217) close not allowing air back into the area of the integral skirt 215. The result is water being entrapped in the integral skirt 215 during wave descent. This in turn adds extra mass to the descent, which can increase power extraction (based on increasing power generated).

In contrast to FIG. 3, FIG. 4 illustrates an example that include a dual or two vertical drive tower configuration 400 utilized in some embodiments of the present invention: the first vertical drive tower 435a and the second vertical drive tower 435b. Like FIG. 3, FIG. 4 illustrates the attachment of the cables 460a, 460b to the one-way clutches 440a, 440b on the drive shaft 450. The first cable 460a, is attached to a frontside 441 of a first one-way clutch 440a, and a second cable 460b, is attached to the backside 442 of the second one-way clutch 440b. The drive 420 moves up and down. When the drive 420 is moving upwards, the drive shaft 450 rotates in a first direction (e.g., clockwise). When the drive shaft 420 moves in a downward direction, the drive shaft 450 can rotate in the same direction (e.g., clockwise). In this example, while both vertical drive towers are moving upwards, the first cable 460a drives the drive shaft 450 clockwise via the one-way the first clutch 440a. Simultaneously, in this example, the second cable 460b is re-wound on the second one-way clutch 440b with a recoil spring (behind the second clutch 440b and not visible in FIG. 4). During a downwards motion, the first cable 460a is re-wound on the first one-way clutch 440a, with the recoil spring 443. Simultaneously, the second cable 460b drives the drive shaft 450 clockwise.

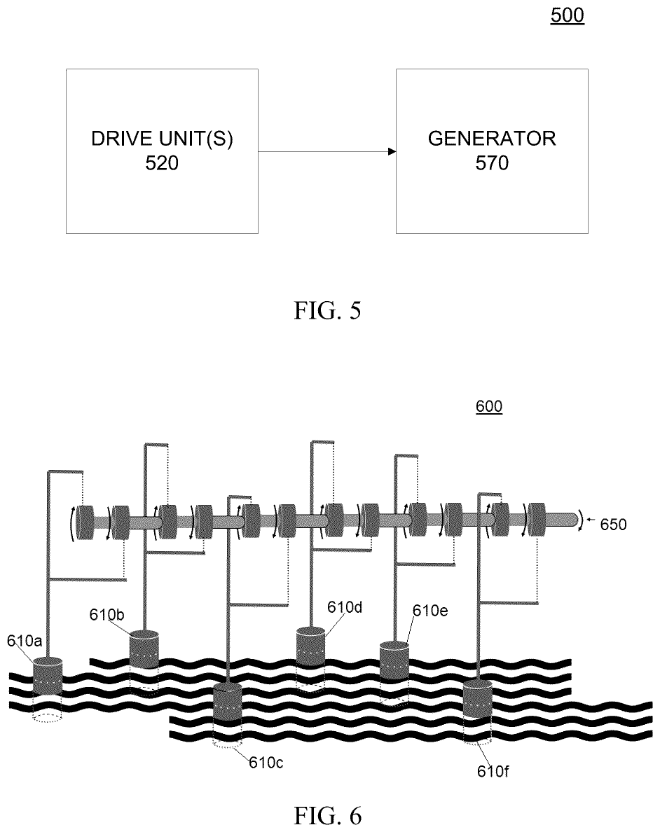

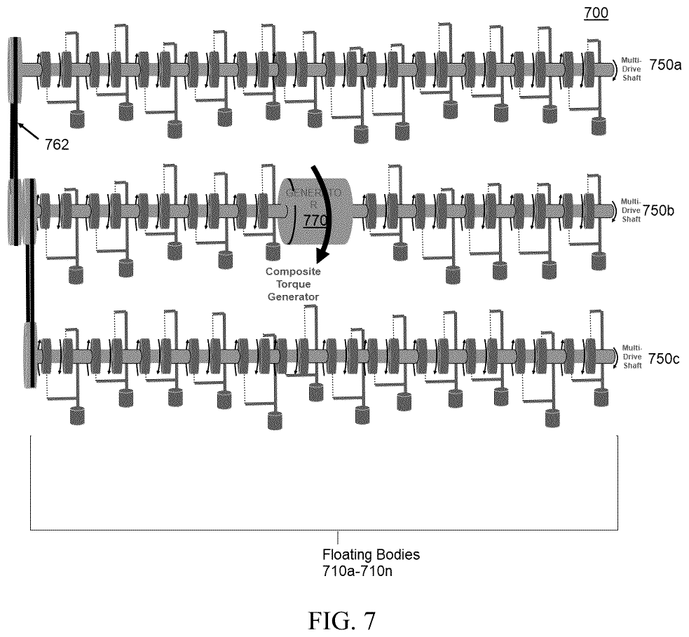

In the examples herein, one or more drives or drive units power a generator, providing power based on wave movements. FIG. 5 illustrates the drive unit(s) 520 to generator 570 connectivity employed in the power generation mechanism 500 in the examples herein. Examples can include one or more drive shaft. FIG. 1, discussed above, illustrates an example 100 with one drive shaft 150 and one floating body 110. FIG. 6 is an example 600 with more than one floating body 610a-610f (the number of floating bodies is provided as a non-limiting example and can vary based on power generation requirements for the implementation) and a single drive shaft 650. Meanwhile, FIG. 7 illustrates an example with more than one floating body 710a-710n (the number of floating bodies illustrated in FIG. 7 is provided as a non-limiting example and can vary based on power generation requirements for the implementation) and multiple drive shafts 750a-750c (this number of drive shafts provided is shown for illustrative purposes as a non-limiting example). FIG. 5 illustrates aspects of each of these examples 100, 600, 700, because each includes at least one drive unit 520 (e.g., drive shafts 150, 650, 750a-750c) which can be coupled to at least one generator 570. The main generator can include, but is not limited to, a constant voltage DC or synchronous AC generator that may include a power system stabilizer.

The continuity of the torque signature produced by various embodiments of the present invention can vary. FIG. 1 depicts an example with one floating body 110 and additional embodiments of the present invention can include multiple floating bodies 610a-610f, 710-710n (e.g., FIG. 6, FIG. 7) working together in unity. FIGS. 1 and 6 illustrate examples with a single drive 120, 620 (e.g., FIG. 5 drive unit 520). In some instances, when a single drive unit 520 is attached to a generator, the drive unit 520 can have a discontinuous torque signature. In some instances, the drive unit 520 generates no torque (or close to no torque) when the float (e.g., FIG. 1, 110) is momentarily still during a crest or a trough of a wave. To create a more continuous torque signature, the example 600 in FIG. 6 includes multiple floating bodies 610a-610f, in series. The multiple floating bodies 610-610f on a common drive shaft 650 will rarely, if at all, experience simultaneous crests and/or troughs. FIG. 7 illustrates an example 700 that generates greater torque and continuous torque because the multiple drive shafts 750a-750c enable a more even distribution of torque.

Referring to FIG. 7, the drive shafts 750a-750c are coupled together and in this configuration, can drive a common generator 770 (e.g., FIG. 5, 570). FIG. 7 illustrates a non-limiting examples of a possible configuration of multiple drive shafts 750a-750c in an embodiment of the present invention. This configuration can statistically eliminate “no-torque” situations and can increase output to the generator 770 (e.g., FIG. 5, 570). The generator can be understood as a composite torque generator 770. In this example, the drive shafts 750a-750c are coupled via a connecting mechanism 762 (e.g., a shaft linkage), which can include, but is not limited to, chains, gears, etc. Various arrows are provided in FIG. 7 to provide examples of the rotation of the shafts 750a-750b to generate power (the varying toques are combined into a composite torque). FIG. 7 can be understood as a multi-shaft power plant.

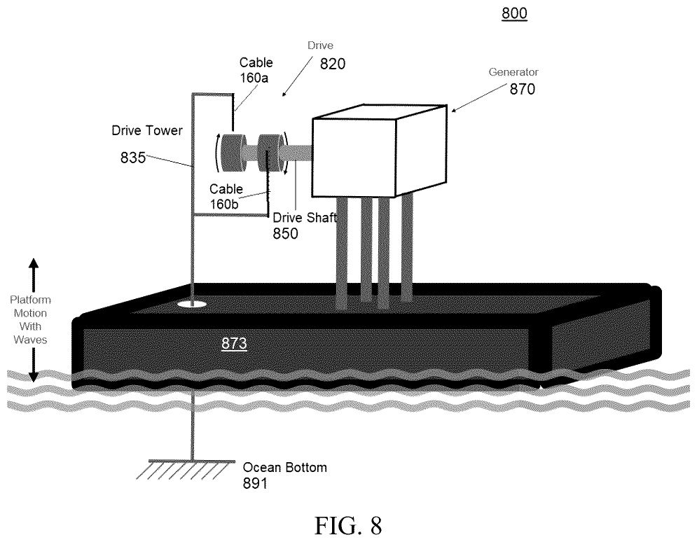

FIG. 8 is an example of another configuration 800 of the examples described herein. FIGS. 1-4 and 6-7 illustrate aspects of embodiments of the present invention that can include a fixed platform and a floating body with at least one drive tower that moves up and down (as illustrated with an axis in FIG. 1). In FIG. 8, a drive tower 835 is fixed to the ocean bottom 891 while a platform 873 moves up and down. The movement of the platform 873 causes the generator 870, which is connected coupled to a drive shaft 850 to move up and down. With the drive shaft 850 moving up and down, the cables, the first cable 160a and the second cable 160b, will extract and retract as described in earlier examples.

Embodiments of the present invention include an apparatus and a method which both employ a floating body to extract power from wave activity or any other reciprocating activity. The apparatus can include a floating body, wherein the floating body reciprocates in a vertical direction based on motion; and a drive assembly, the drive assembly comprising: a drive tower connected to the floating body to move upwards and downwards in the vertical direction based on the movement of the floating body; at least one driving arm connected to the drive tower such that each driving arm of the at least one driving arm extends in a direction perpendicular to the vertical direction; at least one cable coupling the at least one driving arm to a clutch on a drive shaft; and the drive shaft, wherein the drive shaft rotates based on the movement of the floating body.

In some examples of the apparatus, at least one driving arm comprises a first driving arm and a second driving arm and the at least one cable comprises a first cable coupled to the first driving arm and a second cable coupled to the second driving arm.

In some examples of the apparatus, the drive shaft comprises a first one-way clutch and a second one-way clutch and wherein the first one-way clutch and the second one-way clutch rotate in a common direction.

In some examples of the apparatus, the first cable is coupled to the first one-way clutch and the second cable is coupled to the second one-way clutch.

In some examples of the apparatus, the first cable is coupled to the first one-way clutch at a first position and the second cable is coupled to the second one-way clutch at a second position.

In some examples of the apparatus, the floating body comprises: a sealed flotation container; and a skirt attached to the sealed floatation container and extending in the vertical direction, downward from the sealed floatation container.

In some examples of the apparatus, the skirt comprises air bleed valves.

In some examples of the apparatus, where the skirt is a cylinder, a first circular surface of the skirt is closed and a second circular surface of the skirt is open.

In some examples of the apparatus, the air bleed valves comprise one-way air bleed values.

In some examples of the apparatus, the drive assembly further comprises a first recoil spring to wind the first cable and a second recoil spring to wind the second recoil cable.

In some examples of the apparatus, the drive comprising a rigid material.

In some examples of the apparatus, the drive comprises metal.

In some examples of the apparatus, the apparatus includes a generator coupled to the drive assembly.

In some examples, the at least one driving arm is selected from the group consisting of: a one drive tower configuration and a two drive tower configuration.

In some examples, the floating body is positioned proximate to a body of water, and the reciprocating of the floating body in a vertical direction is based on the motion comprising motion of waves within the body of water.

In some examples, the floating body comprises a group of floating bodies connected in series to the drive shaft.

In some examples, the apparatus includes one or more additional drive assemblies, each of the one or more drive assemblies comprising: an additional drive connected to one or more additional floating bodies to move upwards and downwards in the vertical direction based on the movement of the floating body; at least one additional driving arm connected to the additional drive such that each driving arm of the at least one additional driving arm extends in a direction perpendicular to the vertical direction; at least one additional cable coupling the at least one additional driving arm to an additional clutch on an additional drive shaft; and the additional drive shaft, wherein the drive shaft rotates based on the movement of the one or more additional floating bodies, wherein the one or more additional floating bodies are connected in series to the additional drive shaft.

In some examples, the apparatus includes: a floating body, where the floating body is positioned proximate to a body of water such that movement of the floating body comprises the floating body reciprocating in a vertical direction based on motion of waves within the body of water; and a drive assembly, the drive assembly comprising: a drive connected to the floating body to move upwards and downwards in the vertical direction based on the movement of the floating body; at least one driving arm connected to the drive such that each driving arm of the at least one driving arm extends in a direction perpendicular to the vertical direction; at least one cable coupling the at least one driving arm to a clutch on a drive shaft; and the drive shaft, where the drive shaft rotates based on the movement of the floating body.

In some examples of the method, the method includes: placing an apparatus in a body of water, where the body of water experiences wave activity, the apparatus comprising: a floating body, where the floating body is positioned proximate to the body of water such that movement of the floating body comprises the floating body reciprocating in a vertical direction based on the wave activity; a drive assembly, the drive assembly comprising: a drive connected to the floating body to move upwards and downwards in the vertical direction based on the movement of the floating body; at least one driving arm connected to the drive such that each driving arm of the at least one driving arm extends in a direction perpendicular to the vertical direction; at least one cable coupling the at least one driving arm to a clutch on a drive shaft; and the drive shaft, where the drive shaft rotates based on the movement of the floating body; and extracting power from the apparatus based on the apparatus experiencing the wave activity, where based on the wave activity, comprising successive waves, the drive assembly moves upwards and downwards in the vertical direction and the drive shaft rotates clockwise during both the upwards and the downwards motion.

In some examples of the method, the at least one driving arm comprises a first driving arm and a second driving arm and the at least one cable comprising a first cable coupled to the first driving arm and a second cable couple to the second driving arm, and where the drive assembly further comprises: a first one-way clutch; and a second one-way clutch.

In some examples of the method, the drive assembly further comprises: a first recoil spring to wind the first cable around the first one-way clutch; and a second recoil spring to wind the second cable around the second one-way clutch.

In some examples of the method, the drive shaft rotating clockwise during both the upwards and the downwards motion further comprises: during the upwards motion, driving, by the first cable, the drive shaft clockwise via the first one-way clutch; and during the upwards motion, winding, by the second recoil spring, the second cable around the second one-way clutch.

In some examples of the method, the drive shaft rotating clockwise during both the upwards and the downwards motion further comprises: during the downwards motion, driving, by the second cable, the drive shaft clockwise via the second one-way clutch; and during the downwards motion, winding, by the first recoil spring, the first cable around the second one-way clutch.

In some examples of the method, the floating body comprises: a sealed flotation container; and a skirt attached to the sealed floatation container and extending in the vertical direction, downward from the sealed floatation container, where the skirt comprises air bleed valves, where the skirt is a cylinder, where a first circular surface of the skirt is closed and a second circular surface of the skirt is open.

In some examples of the method, the method further comprises: during the upwards motion, opening the air bleed valves to expel trapped air from the skirt.

In some examples of the method, the method further comprises: during the downwards motion, closing the air bleed valves to trap water in the skirt.

In some examples of the method, the method further comprises: increasing the power extracted from the apparatus based on trapping the water in the skirt.

In some examples of the apparatus, the apparatus includes: a floating body, wherein the floating body is positioned proximate to a body of water such that movement of the floating body comprises the floating body reciprocating in a vertical direction based on motion of waves within the body of water; and a drive assembly, the drive assembly comprising: at least one vertical drive tower coupled to the floating body to move upwards and downwards in the vertical direction based on the movement of the floating body; at least one driving arm connected to the at least one vertical drive tower such that each driving arm of the at least one driving arm extends in a direction perpendicular to the vertical direction; at least one cable coupling each driving arm of the at least one driving arm to a clutch selected from one or more clutches on one or more drive shafts; and the one or more drive shafts, where each of the one or more drive shafts rotates based on the movement of the floating body.

In some examples of the apparatus, the apparatus includes one or more floating bodies, where the one or more floating bodies are positioned proximate to a body of water such that movement of the one or more floating bodies comprises the one or more floating bodies reciprocating in a vertical direction based on motion of waves within the body of water. The apparatus can also include one or more drive assemblies, each of the one or more drive assemblies comprising: at least one vertical drive tower coupled to at least one floating body of the one or more floating bodies to move the at least one floating body upwards and downwards in the vertical direction; at least one driving arm connected to the at least one vertical drive tower such that each driving arm of the at least one driving arm extends in a direction perpendicular to the vertical direction; at least one cable coupling each driving arm of the at least one driving arm to a clutch selected from one or more clutches on one or more drive shafts; and the one or more drive shafts, wherein each of the one or more drive shafts rotates based on the movement of the at least one floating body of the one or more floating bodies.

In some examples of the apparatus, the at least one floating body comprises two or more floating bodies, and wherein the two or more floating bodies are connected to the one or more drive shafts in series.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described to best explain various aspects and the practical application, and to enable others of ordinary skill in the art to understand various embodiments with various modifications as are suited to the particular use contemplated.

What is claimed is:

1. An apparatus comprising:
a floating body, wherein the floating body reciprocates in a vertical direction based on motion; and
a drive assembly, the drive assembly comprising:
a drive tower connected to the floating body to move upwards and downwards in the vertical direction based on the movement of the floating body;
at least one driving arm connected to the drive tower such that each driving arm of the at least one driving arm extends in a direction perpendicular to the vertical direction;
at least one cable coupling the at least one driving arm to a clutch on a drive shaft; and
the drive shaft, wherein the drive shaft rotates based on the movement of the floating body.

2. The apparatus of claim 1, wherein the at least one driving arm comprises a first driving arm and a second driving arm and the at least one cable comprises a first cable coupled to the first driving arm and a second cable coupled to the second driving arm.

3. The apparatus of claim 2, wherein the drive shaft comprises a first one-way clutch and a second one-way clutch and wherein the first one-way clutch and the second one-way clutch rotate in a common direction.

4. The apparatus of claim 3, wherein the first cable is coupled to the first one-way clutch and the second cable is coupled to the second one-way clutch.

5. The apparatus of claim 4, wherein the first cable is coupled to the first one-way clutch at a first position and the second cable is coupled to the second one-way clutch at a second position.

6. The apparatus of claim 1, wherein the floating body comprises:
a sealed flotation container; and
a skirt attached to the sealed floatation container and extending in the vertical direction, downward from the sealed floatation container.

7. The apparatus of claim 6, wherein the skirt comprises air bleed valves.

8. The apparatus of claim 7, wherein the skirt is a cylinder, wherein a first circular surface of the skirt is closed and a second circular surface of the skirt is open.

9. The apparatus of claim 8, wherein the air bleed valves comprise one-way air bleed values.

10. The apparatus of claim 5, wherein the drive assembly further comprises a first recoil spring to wind the first cable and a second recoil spring to wind the second recoil cable.

11. The apparatus of claim 1, further comprising:
a generator coupled to the drive assembly.

12. The apparatus of claim 1, wherein the at least one driving arm is selected from the group consisting of: a one drive tower configuration and a two drive tower configuration.

13. The apparatus of claim 1, wherein the floating body is positioned proximate to a body of water, and wherein the reciprocating of the floating body in a vertical direction is based on the motion comprising motion of waves within the body of water.

14. The apparatus of claim 1, wherein the floating body comprises a group of floating bodies connected in series to the drive shaft.

15. The apparatus of claim 14, further comprising:
one or more additional drive assemblies, each of the one or more drive assemblies comprising:
an additional drive connected to one or more additional floating bodies to move upwards and downwards in the vertical direction based on the movement of the floating body;
at least one additional driving arm connected to the additional drive such that each driving arm of the at least one additional driving arm extends in a direction perpendicular to the vertical direction;
at least one additional cable coupling the at least one additional driving arm to an additional clutch on an additional drive shaft; and
the additional drive shaft, wherein the drive shaft rotates based on the movement of the one or more additional floating bodies, wherein the one or more additional floating bodies are connected in series to the additional drive shaft.

16. The apparatus of claim 15, further comprising:
a generator coupled to at least one shaft selected from the group consisting of: the additional drive shaft of at least one drive assembly of the one or more additional drive assemblies, and the drive shaft.

17. A method comprising:
placing an apparatus in a body of water, wherein the body of water experiences wave activity, the apparatus comprising:
a floating body, wherein the floating body is positioned proximate to the body of water such that movement of the floating body comprises the floating body reciprocating in a vertical direction based on the wave activity;
a drive assembly, the drive assembly comprising:
a drive connected to the floating body to move upwards and downwards in the vertical direction based on the movement of the floating body;
at least one driving arm connected to the drive such that each driving arm of the at least one driving arm extends in a direction perpendicular to the vertical direction;
at least one cable coupling the at least one driving arm to a clutch on a drive shaft; and
the drive shaft, wherein the drive shaft rotates based on the movement of the floating body; and
extracting power from the apparatus based on the apparatus experiencing the wave activity, wherein based on the wave activity, comprising successive waves, the drive assembly moves upwards and downwards in the vertical direction and the drive shaft rotates clockwise during both the upwards and the downwards motion.

18. The method of claim 17, wherein the at least one driving arm comprises a first driving arm and a second driving arm and the at least one cable comprising a first cable coupled to the first driving arm and a second cable couple to the second driving arm, and wherein the drive assembly further comprises:
a first one-way clutch; and
a second one-way clutch.

19. An apparatus comprising:
one or more floating bodies, wherein the one or more floating bodies are positioned proximate to a body of water such that movement of the one or more floating bodies comprises the one or more floating bodies reciprocating in a vertical direction based on motion of waves within the body of water;
one or more drive assemblies, each of the one or more drive assemblies comprising:
at least one vertical drive tower coupled to at least one floating body of the one or more floating bodies to move the at least one floating body upwards and downwards in the vertical direction;
at least one driving arm connected to the at least one vertical drive tower such that each driving arm of the at least one driving arm extends in a direction perpendicular to the vertical direction;
at least one cable coupling each driving arm of the at least one driving arm to a clutch selected from one or more clutches on one or more drive shafts; and
the one or more drive shafts, wherein each of the one or more drive shafts rotates based on the movement of the at least one floating body of the one or more floating bodies.

20. The apparatus of claim 19, wherein the at least one floating body comprises two or more floating bodies, and wherein the two or more floating bodies are connected to the one or more drive shafts in series.
